(19) United States
(12) Patent Application Publication
(10) Pub. No.: US 2025/0390505 A1
(43) Pub. Date: Dec. 25, 2025

(54) LIVE WRITES TO ERASURE CODED VOLUMES WITHOUT PRIOR REPLICATION

(71) Applicant: Dropbox, Inc., San Francisco, CA (US)

(72) Inventors: Rajat Goel, San Jose, CA (US); Ankur Kulshrestha, Issaquah, WA (US); Sandeep Kumar R. Ummadi, Issaquah, WA (US); William R. Fraser, Seattle, WA (US); Joshua Wolfe, Mississauga (CA)

(21) Appl. No.: 18/752,435

(22) Filed: Jun. 24, 2024

(51) Int. Cl. G06F 16/27

(52) U.S. Cl. CPC G06F 16/27

(57) ABSTRACT

The present technology pertains to storing blocks in a storage system that requires fewer I/O operations for processes that are non-latency-sensitive. The present technology collects blocks in a buffer and then performs erasure coding while writing the blocks into storage. The erasure coding can occur without the blocks first being replicated. And the present technology can acknowledge the request to store the blocks to a client providing the blocks even before the blocks are written into the storage.

### BACKGROUND

Replication of data and erasure encoding are common techniques to avoid data loss when storing data storage within data centers. These methodologies preserve data integrity, ensure its availability, and optimize storage efficiency in an era where data is an invaluable asset. Replication, for example, is a straightforward yet effective technique where copies of data are stored in multiple locations or storage devices. This method provides a high level of data availability and durability because if one copy of the data is lost or corrupted, other copies can be readily accessed. The simplicity of replication makes it highly reliable; however, it requires significantly more storage space, as each piece of data is stored multiple times. Erasure encoding is a more sophisticated and space-efficient approach. It involves breaking data into fragments, encoding these fragments with additional information, and then distributing them across different locations. In the event of data loss or corruption, the original data can be reconstructed from the remaining fragments using the additional information. Erasure encoding is advantageous in terms of storage efficiency and cost-effectiveness compared to replication, as it does not require multiple copies of the same data to be stored.

Both replication and erasure encoding play integral roles in managing data within data centers. While replication offers simplicity and high data availability, erasure encoding provides an efficient way to store and protect vast amounts of data without consuming excessive storage space.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a content management system and client devices in accordance with some embodiments of the present technology.

FIG. 2 illustrates a set of data centers in accordance with some embodiments of the present technology.

FIG. 3 illustrates the logical structure of the data storage system in accordance with some embodiments of the present technology.

FIG. 4A illustrates the structure of an object storage device in accordance with some embodiments of the present technology.

FIG. 4B illustrates the structure of a write-ahead log (WAL) in accordance with some embodiments of the present technology.

FIG. 5 illustrates another view of content item storage showing acceptors utilized in erasure coding data blocks to object storage devices without first replicating the data blocks in accordance with some embodiments of the present technology.

FIG. 6A illustrates an example method leading up to a put ( ) request in accordance with some embodiments of the present technology.

FIG. 6B illustrates an example method for handling a put ( ) request for a non-latency-sensitive client in accordance with some embodiments of the present technology.

FIG. 6C illustrates an example method for handling a put ( ) request for a latency-sensitive client in accordance with some embodiments of the present technology.

FIG. 7 shows an example of a system for implementing certain aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Replication of data and erasure encoding are common techniques to avoid data loss when storing data within data storage systems, such as those that utilize data centers to store large amounts of data. These methodologies preserve data integrity, ensure its availability, and optimize storage efficiency in an era where data is an invaluable asset. Replication, for example, is a straightforward yet effective technique where copies of data are stored in multiple locations or storage devices. This method provides a high level of data availability and durability because if one copy of the data is lost or corrupted, other copies can be readily accessed. The simplicity of replication makes it highly reliable; however, it requires significantly more storage space, as each piece of data is stored multiple times. Erasure encoding is a more sophisticated and space-efficient approach. It involves breaking data into fragments, encoding these fragments with additional information, and then distributing them across different locations. In the event of data loss or corruption, the original data can be reconstructed from the remaining fragments using the additional information. Erasure encoding is advantageous in terms of storage efficiency and cost-effectiveness compared to replication, as it does not require multiple copies of the same data to be stored. However, it relies on more complex algorithms and computational processes to encode and decode the data, which can introduce additional latency in data retrieval compared to replication. Both replication and erasure encoding play integral roles in managing data within data centers. While replication offers simplicity and high data availability, erasure encoding provides an efficient way to store and protect vast amounts of data without consuming excessive storage space.

Over time, the amount of data that can be stored on a physical object storage device has continued to increase. While this has benefits in needing fewer object storage devices to store the same amount of data, it also means that any given object storage device needs to accommodate more read and write transactions, called input/output or I/O operations. Unfortunately, the amount of I/O operations that an object storage device can perform has not increased to keep pace with the amount of data that the object storage devices can store, which leads to more latency when performing some I/O operations.

One solution to the problem of increased latency due to the increasing number of I/O operations is to reduce the number of I/O operations. The present technology attempts to reduce the number of I/O operations by changing the way a data storage system handles replication and erasure coding for some data.

As addressed above, it is common for data storage systems to utilize replication of data and erasure encoding techniques to manage sometimes competing objectives of quickly storing data so that it is accessible to clients, and efficiently storing the data in a fault-tolerant way. Some data storage systems manage these sometimes competing objectives by initially replicating data received by the data storage system. Initial replication is fast and protects against possible data loss if one object storage device fails. Some data storage systems might replicate a data object, such as a block of a content item, 2, 4, 8, or more times. Each replication is a put ( ) I/O operation.

However, simple replication is not particularly efficient, so these data storage systems might later perform erasure coding on the data. But erasure coding would involve reading the data, and performing additional writes, thus increasing the number of I/O operations.

Here is a simple example. A block of data is received that is 4 MBs, and it is replicated to have two copies. That is two put ( ) I/O operations and 8 MBs of total data. Later, part of the erasure coding, that 4 MB block of data is broken into four 1 MB blocks, so that requires one get ( ) I/O operation and four put ( ) I/O operations. Those four blocks are then distributed using an erasure coding algorithm across eight object storage devices resulting in eight put ( ) I/O operations, which brings the total to at least fifteen I/O operations in this very simplistic example.

The present technology somewhat reduces the number of I/O operations by skipping the data replication when the data is being put ( ) to the data storage system by a non-latency-sensitive client. When the client is not likely to get ( ) the data soon after putting the data to the data storage system, there is no need to do the replication.

The present technology provides a much greater amount of I/O efficiency than the above example reveals because sophisticated data storage systems also use other techniques like storing data in volumes, which can further reduce the number of I/O operations using the present technology.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

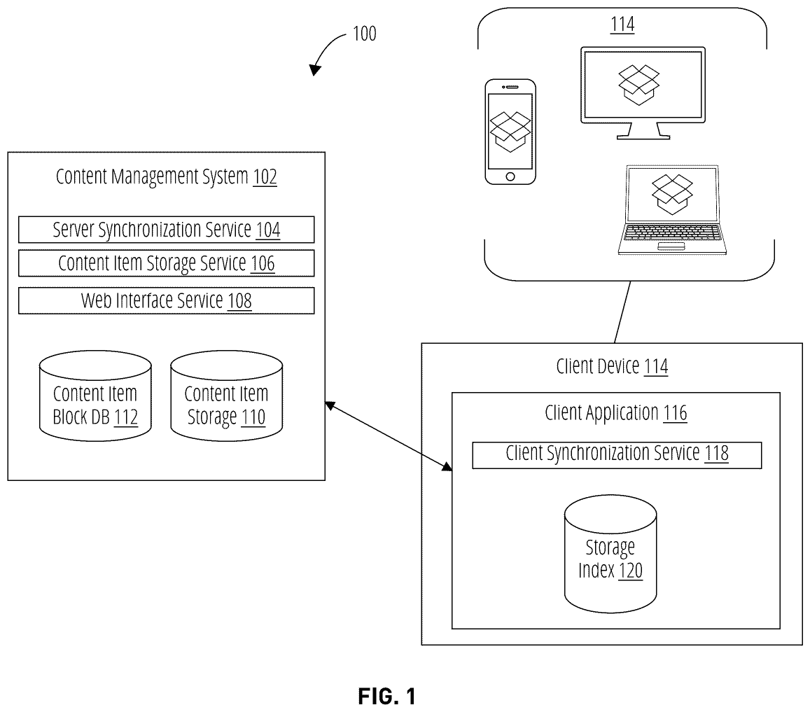

In some embodiments the disclosed technology is deployed in the context of a content management system having content item synchronization capabilities and collaboration features, among others. An example system configuration 100 is shown in FIG. 1, which depicts content management system 102 interacting with client device 114. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

### Accounts

Content management system 102 can store content items in association with accounts, as well as perform a variety of content item management tasks, such as retrieve, modify, browse, and/or share the content item(s). Furthermore, content management system 102 can enable an account to access content item(s) from multiple client devices.

Content management system 102 supports a plurality of accounts. A subject (user, group, team, company, etc.) can create an account with content management system.

### Content Item Storage

A feature of content management system 102 is the storage of content items, which can be stored in content item storage 110. A content item generally is any entity that can be recorded in a file system. Content items can be any object including digital data such as documents, collaboration content items, text files, audio files, image files, video files, webpages, executable files, binary files, content item directories, folders, zip files, playlists, albums, symlinks, cloud docs, mounts, placeholder content items referencing other content items in content management system 102 or in other content management systems, etc.

In some embodiments, content items can be grouped into a collection, which can refer to a folder including a plurality of content items, or a plurality of content items that are related or grouped by a common attribute.

In some embodiments, content item storage 110 is combined with other types of storage or databases to handle specific functions. Content item storage 110 can store content items, while metadata regarding the content items can be stored in a metadata database. Likewise, data regarding where a content item is stored in content item storage 110 can be stored in content item block database 112. Thus, content management system 102 may include more or less storages and/or databases than shown in FIG. 1.

In some embodiments, content item storage 110 is associated with at least one content item storage service 106, which includes software or other processor executable instructions for managing the storage of content items including, but not limited to, receiving content items for storage, preparing content items for storage, selecting a storage location for the content item, retrieving content items from storage, etc. In some embodiments, content item storage service 106 can divide a content item into smaller chunks for storage at content item storage 110. The location of each chunk making up a content item can be recorded in content item block database 112. Content item block database 112 can include a content entry for each content item stored in content item storage 110. The content entry can be associated with a content item ID, which uniquely identifies a content item.

In some embodiments, content items and chunks of content items can also be identified from a deterministic hash function. This method of identifying a content item and chunks of content items can ensure that content item duplicates are recognized as such since the deterministic hash function will output the same hash for every copy of the same content item, but will output a different hash for a different content item. Using this methodology, content item storage service 106 can output a unique hash for each different version of a content item.

Content item storage service 106 can also designate or record a parent of a content item or a content path for a content item. The content path can include the name of the content item and/or folder hierarchy associated with the content item. For example, the content path can include a folder or path of folders in which the content item is stored in a local file system on a client device. In some embodiments, content item database might only store a direct ancestor or direct child of any content item, which allows a full path for a content item to be derived, and can be more efficient than storing the whole path for a content item.

While content items are stored in content item storage 110 in blocks and may not be stored under a tree like directory structure, such directory structure is a comfortable navigation structure for subjects viewing content items. Content item storage service 106 can define or record a content path for a content item wherein the “root” node of a directory structure can be any directory with specific access privileges assigned to it, as opposed to a directory that inherits access privileges from another directory.

In some embodiments, a root directory can be mounted underneath another root directory to give the appearance of a single directory structure. This can occur when an account has access to a plurality of root directories. As addressed above, the directory structure is merely a comfortable navigation structure for subjects viewing content items, but does not correlate to storage locations of content items in content item storage 110.

While the directory structure in which an account views content items does not correlate to storage locations of the content items at content management system 102, the directory structure can correlate to storage locations of the content items on client device 114 depending on the file system used by client device 114.

As addressed above, a content entry in content item block database 112 can also include the location of each chunk making up a content item. More specifically, the content entry can include content pointers that identify the location in content item storage 110 of the chunks that make up the content item.

Content item storage service 106 can decrease the amount of storage space required by identifying duplicate content items or duplicate blocks that make up a content item or versions of a content item. Instead of storing multiple copies, content item storage 110 can store a single copy of the content item or block of the content item, and content item block database 112 can include a pointer or other mechanism to link the duplicates to the single copy.

Content item storage service 106 can also store metadata describing content items, content item types, folders, file path, and/or the relationship of content items to various accounts, collections, or groups, in association with the content item ID of the content item.

Content item storage service 106 can also store a log of data regarding changes, access, etc.

### Content Item Synchronization

Another feature of content management system 102 is synchronization of content items with at least one client device 114. Client devices 114 can take different forms and have different capabilities. For example, client device 114 can be a computing device having a local file system accessible by multiple applications resident thereon. Client device 114 can be a computing device wherein content items are only accessible to a specific application or by permission given by the specific application, and the content items are typically stored either in an application specific space or in the cloud. Client device 114 can be any client device accessing content management system 102 via a web browser and accessing content items via a web interface. While example client device 114 is depicted in form factors such as a laptop, mobile device, or web browser, it should be understood that the descriptions thereof are not limited to devices of these example form factors. For example, a mobile device might have a local file system accessible by multiple applications resident thereon or might access content management system 102 via a web browser. As such, the form factor should not be considered limiting when considering client device 114's capabilities. One or more functions described herein with respect to client device 114 may or may not be available on every client device depending on the specific capabilities of the device—the file access model being one such capability.

In many embodiments, client devices 114 are associated with an account of content management system 102, but in some embodiments client device 114 can access content using shared links and do not require an account.

As noted above, some client devices can access content management system 102 using a web browser. However, client devices can also access content management system 102 using client application 116 stored and running on client device 114. Client application 116 can include a client synchronization service 118.

Client synchronization service 118 can be in communication with server synchronization service 104 to synchronize changes to content items between client device 114 and content management system 102.

Client device 114 can synchronize content with content management system 102 via client synchronization service 118. The synchronization can be platform agnostic. That is, content can be synchronized across multiple client devices of varying types, capabilities, operating systems, etc. Client synchronization service 118 can synchronize any changes (e.g., new, deleted, modified, copied, or moved content items) to content items in a designated location of a file system of client device 114.

Content items can be synchronized from client device 114 to content management system 102, and vice versa. In embodiments wherein synchronization is from client device 114 to content management system 102, a subject can manipulate content items directly from the file system of client device 114, while client synchronization service 118 can monitor directory on client device 114 for changes to files within the monitored folders.

When client synchronization service 118 detects a write, move, copy, or delete of content in a directory that it monitors, client synchronization service 118 can synchronize the changes to content item storage service 106. In some embodiments, client synchronization service 118 can perform some functions of content item storage service 106 including functions addressed above such as dividing the content item into blocks, hashing the content item to generate a unique identifier, etc. Client synchronization service 118 can index content within client storage index 120 and save the result in client storage index 120. Indexing can include storing paths plus the content item identifier, and a unique identifier for each content item. In some embodiments, client synchronization service 118 learns the content item identifier from server synchronization service 104, and learns the unique client identifier from the operating system of client device 114.

Client synchronization service 118 can use storage index 120 to facilitate the synchronization of at least a portion of the content items within client storage with content items associated with a subject account on content management system 102. For example, client synchronization service 118 can compare storage index 120 with content management system 102 and detect differences between content on client storage and content associated with a subject account on content management system 102. Client synchronization service 118 can then attempt to reconcile differences by uploading, downloading, modifying, and deleting content on client storage as appropriate.

In some embodiments, storage index 120 stores tree data structures wherein one tree reflects the latest representation of a directory according to server synchronization service 104, while another tree reflects the latest representation of the directory according to client synchronization service 118. Client synchronization service 118 can work to ensure that the tree structures match by requesting data from server synchronization service 104 or committing changes on client device 114 to content management system 102.

Sometimes client device 114 might not have a network connection available. In this scenario, client synchronization service 118 can monitor the linked collection for content item changes and queue those changes for later synchronization to content management system 102 when a network connection is available. Similarly, a subject can manually start, stop, pause, or resume synchronization with content management system 102.

Client synchronization service 118 can synchronize all content associated with a particular subject account on content management system 102. Alternatively, client synchronization service 118 can selectively synchronize some of the content items associated with the particular subject account on content management system 102. Selectively synchronizing only some of the content items can preserve space on client device 114 and save bandwidth.

In some embodiments, client synchronization service 118 selectively stores a portion of the content items associated with the particular subject account and stores placeholder content items in client storage for the remainder portion of the content items. For example, client synchronization service 118 can store a placeholder content item that has the same filename, path, extension, metadata, of its respective complete content item on content management system 102, but lacking the data of the complete content item. The placeholder content item can be a few bytes or less in size while the respective complete content item might be significantly larger. After client device 114 attempts to access the content item, client synchronization service 118 can retrieve the data of the content item from content management system 102 and provide the complete content item to client device 114. This approach can provide significant space and bandwidth savings while still providing full access to a subject's content items on content management system 102.

While the synchronization embodiments addressed above referred to client device 114 and a server of content management system 102, it should be appreciated by those of ordinary skill in the art that a user account can have any number of client devices 114 all synchronizing content items with content management system 102, such that changes to a content item on any one client device 114 can propagate to other client devices 114 through their respective synchronization with content management system 102.

### Content Item Access

Content item storage service 106 can receive a token from client application 116 that follows a request to access a content item and can return the capabilities permitted to the subject account.

In some embodiments, one or more of the services or storages/databases discussed above can be accessed using public or private application programming interfaces.

Certain software applications can access content item storage 110 via an API on behalf of a subject. For example, a software package such as an application running on client device 114, can programmatically make API calls directly to content management system 102 when a subject provides authentication credentials, to read, write, create, delete, share, or otherwise manipulate content.

A subject can view or manipulate content stored in a subject account via a web interface generated and served by web interface service 108. For example, the subject can navigate in a web browser to a web address provided by content management system 102. Changes or updates to content in the content item storage 110 made through the web interface, such as uploading a new version of a content item, can be propagated back to other client devices associated with the subject's account. For example, multiple client devices, each with their own client software, can be associated with a single account and content items in the account can be synchronized between each of the multiple client devices.

Client device 114 can connect to content management system 102 on behalf of a subject. A subject can directly interact with client device 114, for example when client device 114 is a desktop or laptop computer, phone, television, internet-of-things device, etc. Alternatively or additionally, client device 114 can act on behalf of the subject without the subject having physical access to client device 114, for example when client device 114 is a server.

Some features of client device 114 are enabled by an application installed on client device 114. In some embodiments, the application can include a content management system specific component. For example, the content management system specific component can be a stand-alone client application 116, one or more application plug-ins, and/or a browser extension. However, the subject can also interact with content management system 102 via a third-party application, such as a web browser, that resides on client device 114 and is configured to communicate with content management system 102. In various implementations, the client application 116 can present a subject interface (UI) for a subject to interact with content management system 102. For example, the subject can interact with the content management system 102 via a file system explorer integrated with the file system or via a webpage displayed using a web browser application.

In some embodiments, client application 116 can be configured to manage and synchronize content for more than one account of content management system 102. In such embodiments client application 116 can remain logged into multiple accounts and provide normal services for the multiple accounts. In some embodiments, each account can appear as folder in a file system, and all content items within that folder can be synchronized with content management system 102. In some embodiments, client application 116 can include a selector to choose one of the multiple accounts to be the primary account or default account.

### Third Party Services

In some embodiments content management system 102 can include functionality to interface with one or more third party services such as workspace services, email services, task services, etc. In such embodiments, content management system 102 can be provided with login credentials for a subject account at the third party service to interact with the third party service to bring functionality or data from those third party services into various subject interfaces provided by content management system 102.

While content management system 102 is presented with specific components, it should be understood by one skilled in the art, that the architectural system configuration 100 is simply one possible configuration and that other configurations with more or fewer components are possible. Further, a service can have more or less functionality, even including functionality described as being with another service. Moreover, features described herein with respect to an embodiment can be combined with features described with respect to another embodiment.

While system 100 is presented with specific components, it should be understood by one skilled in the art, that the architectural system configuration 100 is simply one possible configuration and that other configurations with more or fewer components are possible.

### Data Centers

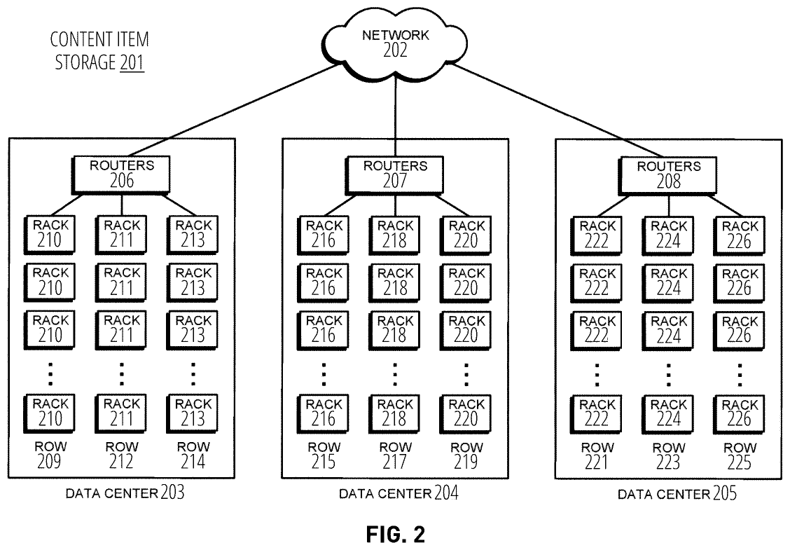

FIG. 2 illustrates an exemplary content item storage 201 that comprises a set of data centers 203, 204, and 205 in accordance with the disclosed embodiments. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

Data centers provide the infrastructure for the content item storage 201. Note that content item storage 201 can be smaller than the system illustrated in FIG. 2. (For example, content item storage 201 can comprise a single server that is connected to a number of disk drives, a single rack that houses a number of servers, a row of racks, or a single data center with multiple rows of racks.) As illustrated in FIG. 2, content item storage 201 can include a set of geographically distributed data centers 203-205 that may be located in different states, different countries or even on different continents.

Data centers 203-205 are coupled together through a network 202, wherein network 202 can be a private network with dedicated communication links, or a public network, such as the Internet, or a virtual-private network (VPN) that operates over a public network.

Communications to each data center pass through a set of routers that route the communications to specific storage nodes within each data center. More specifically, communications with data center 203 pass through routers 206, communications with data center 204 pass through routers 207, and communications with data center 205 pass through routers 208.

As illustrated in FIG. 2, routers 206-208 channel communications to storage devices within the data centers, wherein the storage devices are incorporated into servers that are housed in racks, wherein the racks are organized into rows within each data center. For example, the racks within data center 203 are organized into row 209, 212 and 214, wherein row 209 includes racks 210, row 212 includes racks 211 and row 214 includes racks 213. The racks within data center 204 are organized into row 215, row 217 and row 219, wherein row 215 includes racks 216, row 217 includes racks 218 and row 219 includes racks 220. Finally, the racks within data center 205 are organized into row 221, row 223 and row 225, wherein row 221 includes racks 222, row 223 includes racks 224 and row 225 includes racks rack 226.

As illustrated in FIG. 2, content item storage 201 is organized hierarchically, comprising multiple data centers, wherein machines within each data center are organized into rows, wherein each row includes one or more racks, wherein each rack includes one or more servers, and wherein each server (also referred to as an “object storage device” (OSD)) includes one or more storage devices (e.g., disk drives).

### Data Storage System

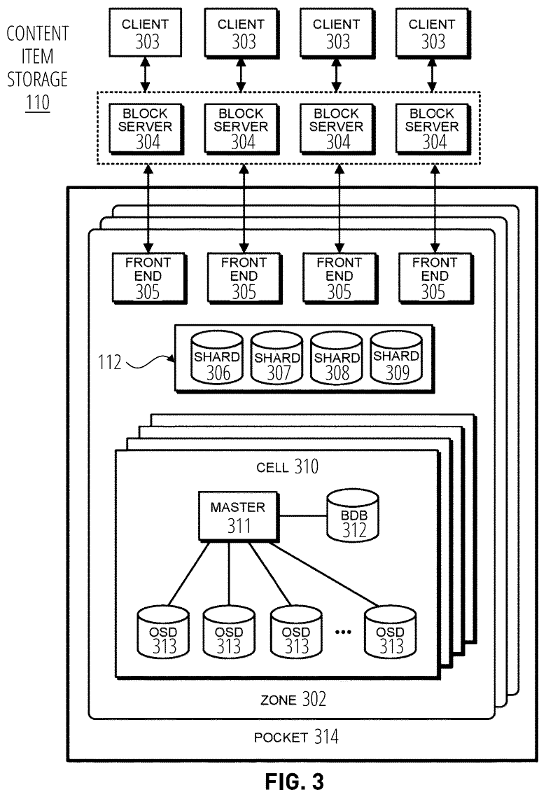

FIG. 3 illustrates the logical structure of the content item storage 110 in accordance with the disclosed embodiments. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

As illustrated in FIG. 3, content item storage 110 includes a logical entity called a “pocket” 314 that, in some embodiments, is similar to an Amazon S3™ bucket. The pockets are distinct. For example, in an exemplary implementation, the system provides a “block storage pocket” to store data files, and a “thumbnail pocket” to store thumbnail images for data objects. Applications, such as client application 116, specify which pockets are to be accessed.

Within a pocket one or more “zones” exist that are associated with physical data centers, and these physical data centers can reside at different geographic locations. For example, one data center might be located in California, another data center might be located in Virginia, and another data center might be located in Europe. For fault-tolerance purposes, data can be stored redundantly by maintaining multiple copies of the data on different servers within a single data center and also across multiple data centers.

For example, when a data item first enters a data center, it can be initially replicated to improve availability and provide fault tolerance. It can then be asynchronously propagated to other data centers.

Note that storing the data redundantly can simply involve making copies of data items, or alternatively using a more space-efficient encoding scheme, such as erasure codes (e.g., Reed-Solomon codes) or Hamming codes to provide fault tolerance.

Within zones (such as zone 302 in FIG. 3), there exists a set of storage front ends 305, a content item block database content item block database 112 and a set of “cells,” such as cell 310 illustrated in FIG. 3. A typical cell 310 includes a number of object storage devices 313, wherein the individual object storage devices 313 include storage devices that actually store data blocks. Cell 310 also includes a storage master 311, which is in charge of managing object storage devices 313 and bucket database 312, described in more detail below. (Note that content item block database 112 and bucket database 312 are logical databases which can be stored redundantly in multiple physical databases to provide fault tolerance.)

Storage master 311 performs a number of actions. For example, storage master 311 can determine how many writeable buckets the system has at any point in time. If the system runs out of buckets, storage master 311 can create new buckets and allocate them to the storage devices. Storage master 311 can also monitor object storage devices 313 and associated storage devices, and if any object storage device 313 or other storage device fails, storage master 311 can migrate the associated buckets to other object storage devices. In some embodiments, storage master 311 is a service which coordinates all volume operations in a pocket 314 cell 310.

As illustrated in FIG. 3, a number of block servers 304, which are typically located in a data center associated with a zone, can service requests from a number of clients 303. For example, a client 303, such as client device 114, can comprise applications running on client machines and/or devices that access data items in content item storage 110. Block servers 304 in turn forward the requests to storage front end 305 that are located within specific zones, such as zone 302 illustrated in FIG. 3. Note that clients 303 communicate with storage front end 305 through block servers 304, and the storage front ends 305 are the only machines within the zones that have public IP addresses.

Content items to be stored in content item storage 110 comprise one or more data blocks that are individually stored in content item storage 110. For example, a large file can be associated with multiple data blocks, wherein each data block is 1 MB to 4 MBs in size.

Moreover, each data block is associated with a “hash” that serves as a global identifier for the data block. The hash can be computed from the data block by running the data block through a hash function, such as a SHA-256 hash function. (The SHA-256 hash function is defined as a Federal Information Processing Standard (FIPS) by the U.S. National Institute of Standards and Technology (NIST).) The hash is used by content item storage 110 to determine where the associated data block is stored.

### Get( ) Operation

The system performs a number of operations while processing data accesses on behalf of a client 303. For example, when a get ( ) operation is received along with an associated hash, the hash is used to perform a lookup in content item block database 112. This lookup returns an identifier for a “bucket” and associated cell where the data block is stored.

To streamline failure-recovery operations, a large number of data blocks can be aggregated into larger buckets. For example, a number of 1-4 MB data blocks can be aggregated into a single 1 GiB bucket, wherein each bucket is stored in a specific cell. This enables the system to manipulate a small number of buckets during a failure-recovery operation instead of manipulating a large number of individual data blocks. Aggregating data blocks into buckets also greatly decreases the amount of metadata the system has to maintain and manipulate; this is advantageous because metadata is computationally expensive to maintain and manipulate.

Because a large number of data blocks can exist in content item storage 110, content item block database 112 can potentially be very large. If content item block database 112 is very large, it is advantageous to structure content item block database 112 as a “sharded” database. For example, when performing a lookup based on a hash in content item block database 112, the first 8 bits of the hash can be used to associate the hash with one of 256 possible shards, and this shard can be used to direct the lookup to an associated instance of content item block database 112. For example, as illustrated in FIG. 3, content item block database 112 can comprise 4 instance 306, 307, 308, and 309, wherein instance 306 is associated with shards 1-64, instance 307 is associated with shards 65-128, instance 308 is associated with shards 129-192 and instance 309 is associated with shards 193-256. In other embodiments, content item block database 112 can be divided into more or fewer instances. (Note that a zone can include a “ZooKeeper™ cluster” that is responsible for mapping shards to specific target cells and also mapping shards to physical content item block database machines.)

In some embodiments, content item block database 112 identifies where in Pocket 314 each block is located (e.g., mapping from the block's key to the cell 310 and Bucket ID, which is recording in bucket database 312.

Content item block database 112 instance 306-309 are logical databases that are mapped to physical databases, and to provide fault tolerance, each logical database can be redundantly stored in multiple physical databases. For example, in one embodiment, each content item block database 112 instance maps to three physical databases. If content item storage 110 is very large (for example containing trillions of data blocks), content item block database 112 will be too large to fit in random-access memory. In this case, content item block database 112 will mainly be stored in non-volatile storage, which for example, can comprise flash drives or disk drives.

In some embodiment, bucket database 312 identifies the object storage device holding each bucket of blocks, and which buckets are in which volumes. A bucket is a logical grouping of blocks. And a volume is a mapping from one or more buckets to the object storage devices storing them.

After the bucket and associated cell are identified for the get ( ) operation, the system performs a lookup in bucket database 312 in the associated cell 310. This lookup returns an identifier for an object storage device 313 where the bucket is located. Note that because each bucket is fairly large (e.g., 1 gibibytes) and contains a large number of data blocks, bucket database 312 is relatively small and can typically be stored in random-access memory, which greatly speeds up the lookup process.

Finally, within the object storage device 313, the system performs a lookup based on the bucket and the hash to determine an offset and a length for the data block in a write-ahead log that stores data blocks for the bucket. The system then returns the data block from the determined offset in the write-ahead log. Note that because content item storage 110 is designed to store “immutable data” that generally does not change after it is written, it is efficient to store the immutable data in a write-ahead log, as opposed to a random-access structure. Because the data is rarely overwritten, writes do not require more complex and time-consuming random-access lookup mechanisms.

### Put( ) Operation

During a put ( ) operation, the system receives a data block to be written from a client. To process the put( ) operation, the system first computes a hash from the data block, for example using the SHA-256 technique described above. Next, the system selects a writeable bucket and an associated cell for the data block. Note that storage front ends 305 periodically poll the bucket databases 312 to identify and then cache writeable buckets. This enables storage front end storage front ends 305 to keep track of a number of buckets (e.g., 10 to 100 buckets) that they know are writeable at any given time. Then, when a put ( ) operation is subsequently received, a front end simply selects a cached bucket that it knows is writable.

Within the associated cell, the system uses an identifier for the selected bucket to perform a lookup in the bucket database 312. This lookup returns one or more object storage devices 313 for the bucket. (Note that the bucket may be replicated across multiple object storage devices 313 to provide fault tolerance.) Within the object storage devices 313, the system appends the data block to a write-ahead log that stores data blocks for the bucket. After the data is stably written to the object storage devices 313, the system writes the hash-to-bucket mapping to the content item block database 112.

Note that the storage master 311 modifies the bucket database 312 and the storage front end 305 modifies the content item block database 112. In general, storage master 311 is concerned with reliability of storage, and hence performs operations to facilitate redundancy and rebalancing, while the storage front end 305 is generally concerned with finding information and simply maps hashes to logical constructs, such as buckets.

Storage master 311 performs various operations to detect and handle failures. More specifically, storage master 311 periodically performs health checks on object storage devices. If storage master 311 detects a failure in an object storage device 313, the associated buckets are degraded and the master sets the buckets to be non-writable. Note that get ( ) operations have to access the buckets where the blocks are stored, but put ( ) operations can be directed to any bucket that is currently writeable, so when a problem happens with a bucket, the system simply marks the bucket as non-writeable. The system can continue performing get ( ) operations on the degraded bucket, because there exist multiple copies of the degraded bucket.

To handle a failure associated with a bucket, storage master 311 tells the associated object storage devices 313 to freeze the bucket. Storage master 311 then tells the object storage devices 313 to replicate the bucket to a new object storage device 313. The system then adds the new object storage device 313 to the cluster, increments the generation number for the object storage device 313, and marks the bucket as writeable. (Note that when a degraded object storage device 313 is restarted after a failure, it will not accept any reads because its generation number is old.) The system guarantees that every object storage device 313 in the current generation has valid data.

The system also includes mechanisms to perform compaction operations. Although the data stored in content item storage 110 is immutable, the system often needs to delete data items when users remove them from the system. In some embodiments, the system tracks deleted data items in a log, and when the usable storage in a given bucket falls below a threshold, the system compacts the bucket.

### Object Storage Device

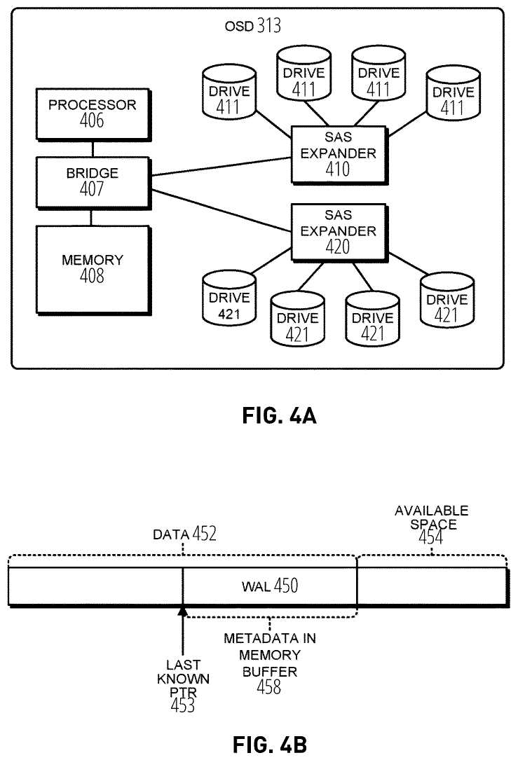

FIG. 4A illustrates the structure of an exemplary object storage device 313 in accordance with the disclosed embodiments. As illustrated in FIG. 4A, object storage device 313 includes a processor 406 that is connected to a memory 408 through a bridge 407. Processor 406 is also coupled to Serial Attached SCSI (SAS) expander 410 and SAS expander 420, where SAS expander 410 is coupled to disk drives 411 and SAS expander 420 is coupled to disk drives 421. (Note that SAS expanders 410 and 420 may be coupled to more or fewer disk drives.) Also, note that a failure in object storage device 313 can involve a failure of a single one of the disk drives disk drive 411 or disk drives 421, or a failure that affects all or most of object storage device 313, such as a failure in processor 406, bridge 407, memory 408, SAS expanders 410 and 420 or one of the associated data paths.

### Write-Ahead Log

FIG. 4B illustrates the structure of a write-ahead log (WAL) 450 which is maintained within an object storage device 313 in accordance with the disclosed embodiments. WAL 450 provides a log-structured content item storage which is advantageous for storing immutable data. WAL 450 comprises one or more 1 gibibytes extents which can be associated with the logical buckets described above. An extent is region on disk where data has been stored. As illustrated in FIG. 4B, an extent can include a data portion 452 that has already been written to, and an unwritten portion that contains available space 454. The data blocks that are stored within data portion 452 are associated with metadata that, for example, contains hashes and the offsets for the data blocks. To improve performance, metadata associated with recently written data blocks 458 can be stored in a memory buffer. When the system recovers from a failure, all of the metadata can be reconstructed by scanning through WAL 450 starting from a last known pointer 453.

During a put( ) operation, the system synchronously appends the data block and an associated header to the WAL 450, wherein the header includes a number of data items associated with the block, including the hash and the length of the block. At the same time, the system synchronously adds metadata to the memory buffer. When a bucket becomes full, the system seals the bucket, and the bucket generally does not get modified again.

During a get( ) operation, the system checks the memory buffer to find the offset and length for the data block. The system then uses the offset and length to read the data block from WAL 450.

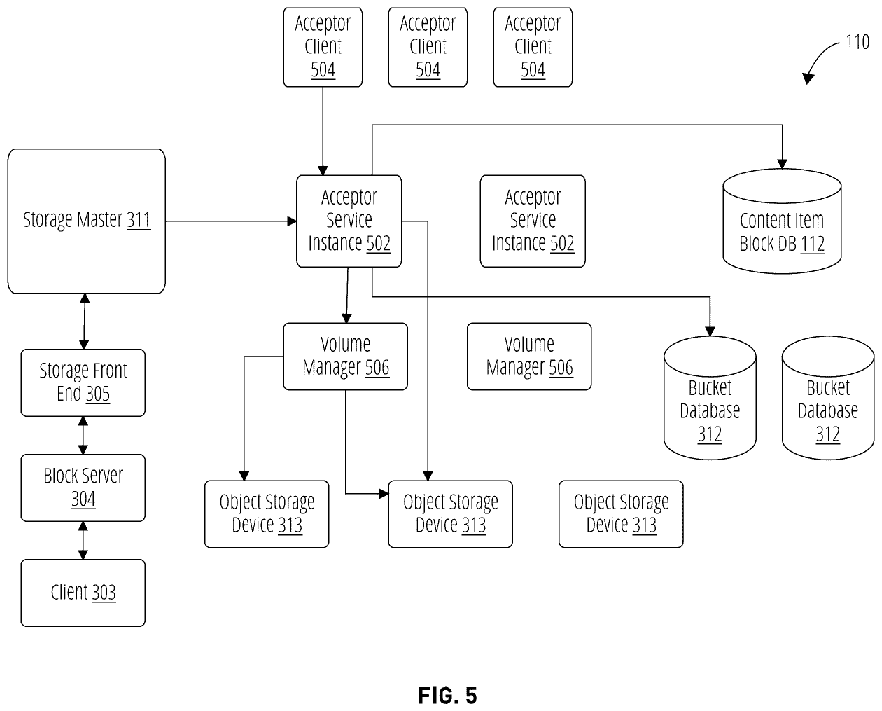

FIG. 5 illustrates another view of content item storage showing acceptors utilized in erasure coding data blocks to object storage devices without first replicating the data blocks in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

FIG. 5 includes several components also illustrated in FIG. 3, but also includes acceptor service 502 and acceptor client 504 which are used in erasure coding data blocks to object storage devices without first replicating the data block. In other words, the system illustrated in FIG. 3 is focused on a system that first replicates data and later performs erasure coding. The main differences are that client 303 in FIG. 3 is a latency-sensitive client, and acceptor client 504 is a non-latency-sensitive client, and that the non-latency-sensitive client calls acceptor service 502 for put ( ) requests instead of storage front end 305 called by the latency-sensitive clients. In some embodiments, a client is a latency-sensitive client because it is making a put ( ) request that is a latency-sensitive request because the data block to be written by the put ( ) request might need to be accessed soon. In some embodiments, a client is a non-latency-sensitive client because it is making a put ( ) request where it is not expected that the data block to be written by the put ( ) request will need to be accessed soon.

It should be noted that the system illustrated in FIG. 3 could be adapted to perform erasure coding of data blocks to object storage devices without first replicating the data block by modifying the role of storage front end 305 to perform the functions of acceptor service 502, described herein.

FIG. 5 illustrates acceptor service 502. Acceptor service 502 is a service which accepts blocks to be directly stored to encoded volumes, and buffering them until volume manager 506 can write them to disk.

In some embodiments acceptor service 502 can be a stateful service responsible for writing blocks directly to available encoded volumes and can send acknowledgements back to the acceptor clients 504 when the blocks have been committed to disk as well as content item block database 112.

In some embodiments, volume manager 506 is a service which performs the erasure coding of data blocks.

In some embodiments, acceptor client 504 is a non-latency-sensitive client. Acceptor clients 504 are configured to establish a connection with acceptor service 502 and be configured to receive an acknowledgment from acceptor service 502 that blocks are being stored, but acceptor clients 504 are configured to understand that the acknowledgment does not mean the blocks are available to be requested yet.

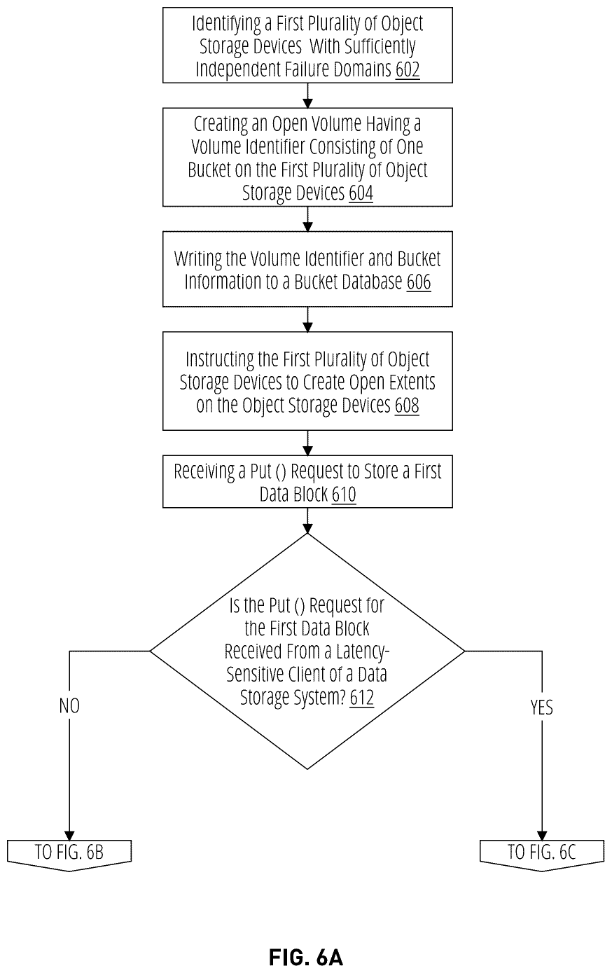

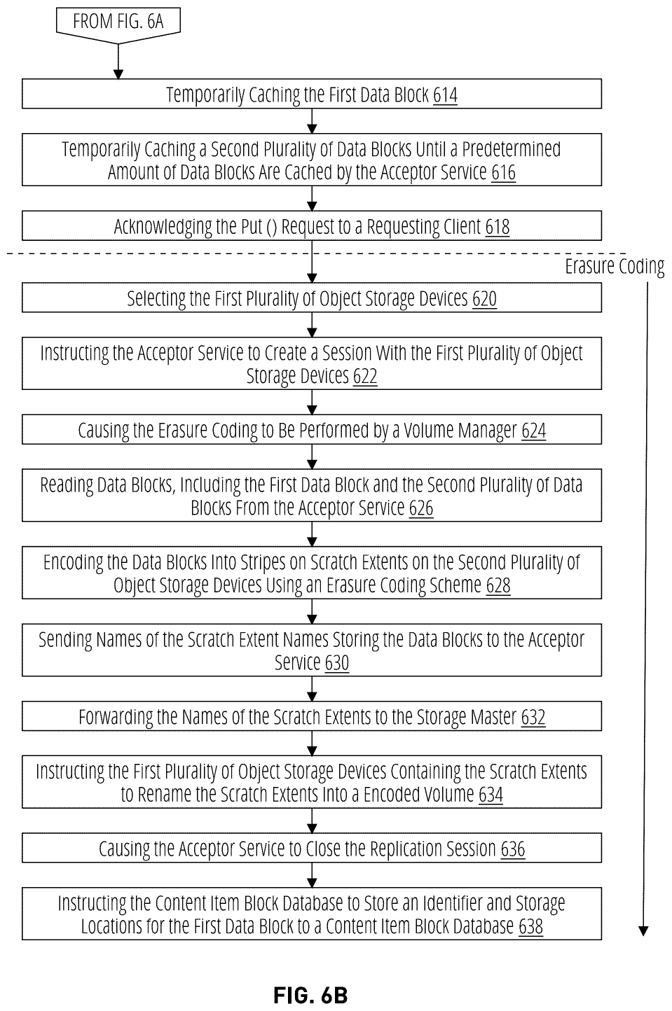

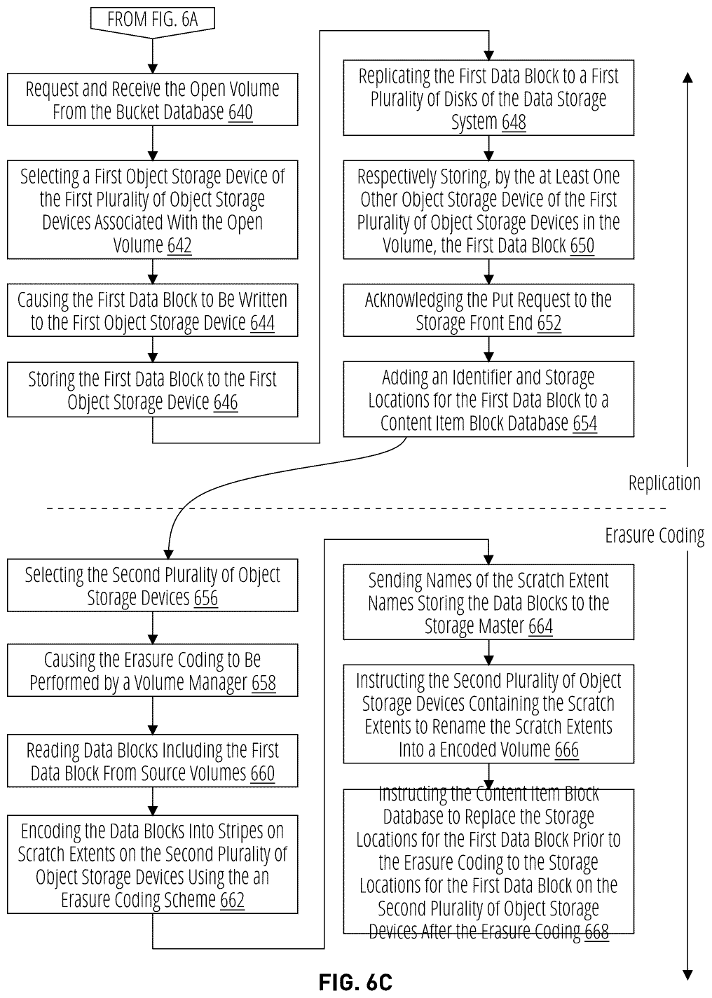

More detail about content item storage 110 illustrated in FIG. 5 will be addressed with respect to FIG. 6A, FIG. 6B, and FIG. 6C.

FIG. 6A illustrates an example method leading up to a put ( ) request in accordance with some embodiments of the present technology. Although the example method depicts a particular sequence of operations, the sequence may be altered without departing from the scope of the present disclosure. For example, some of the operations depicted may be performed in parallel, may be excluded or added, or may be performed in a different sequence that does not materially affect the function of the method. In other examples, different components of an example device or system that implements the method may perform functions at substantially the same time or in a specific sequence.

As addressed above with respect to FIG. 3, storage master 311 can take steps to prepare to receive a put ( ) request and replicate data blocks across object storage devices 313. This process is described with respect to block 602, block 604, block 606, and block 608.

According to some examples, the method includes identifying a first plurality of object storage devices with sufficiently independent failure domains at block 602. For example, the storage master 311 illustrated in FIG. 5 may identify a first plurality of object storage devices with sufficiently independent failure domains. In some embodiments, storage master 311 can identify at least four object storage devices to prepare to replicate a block included in a put ( ) request onto four different object storage devices, as is addressed further with respect to FIG. 6C.

According to some examples, the method includes creating an open volume having a volume identifier consisting of one bucket on the first plurality of object storage devices at block 604. For example, the storage master 311 illustrated in FIG. 5 may create an open volume having a volume identifier consisting of one bucket on the first plurality of object storage devices. There can be more than one open volume. An open volume is a volume with a bucket which can have blocks appended to it.

According to some examples, the method includes writing the volume identifier and bucket information to a bucket database at block 606. For example, the storage master 311 illustrated in FIG. 5 may write the volume identifier and bucket information to bucket database 312.

According to some examples, the method includes instructing the first plurality of object storage devices to create open extents on the object storage devices at block 608. For example, the storage master 311 illustrated in FIG. 5 may instruct the first plurality of object storage devices to create open extents on the object storage devices.

The steps described with respect to block 602, block 604, block 606, and block 608 prepare content item storage 110 to receive a latency-sensitive put ( ) request. However, the present technology pertains to content item storage 110 that can differentiate between latency-sensitive put ( ) requests and non-latency-sensitive put ( ) requests.

According to some examples, the method includes receiving a put ( ) request to store a first data block at block 610. As will be addressed herein, the put ( ) request can be received by the storage front end or by the acceptor service. While the present description refers to a first data block or a second data block, it should be appreciated that this is merely to provide a simple explanation and that, most often, a put ( ) request will include more than a first data block and will include many such first data blocks, depending on the size of the content item that the data blocks make up.

According to some examples, the method includes determining whether the put ( ) request for the first data block is latency-sensitive at decision block 612. It can determined that the put ( ) request for the first data block is latency-sensitive when the client accesses the data storage system through a storage front end and conversely, it can be determined that the put get ( ) request for the first data block is not latency-sensitive when the client accesses the data storage system through an acceptor service. Accordingly, one way to distinguish whether the request is latency-sensitive is based on which service of content item storage 110 the client calls.

In some embodiments, it can be considered that any request that is latency-sensitive is from a latency-sensitive client, and any request that is not latency-sensitive is from a non-latency-sensitive client. A client that makes a latency-sensitive request in one instance need not always make latency-sensitive requests. And a client that makes a non-latency-sensitive request in one instance need not always make non-latency-sensitive requests.

An example of a common latency-sensitive request can come from a client device requesting to make a live write. This can occur in the context of a synchronization operation between a client device and the content management system.

An example of a common non-latency-sensitive request can be from the storage system performing maintenance on object storage devices or otherwise moving data objects for any number of reasons.

In some embodiments, a client can identify itself or the request as latency-sensitive or a non-latency-sensitive in its put ( ) request.

In some embodiments, it can determined that the first data block is from a latency-sensitive client by default unless the client explicitly indicates that it is a non-latency-sensitive client in the put ( ) request or by calling the appropriate access point for non-latency-sensitive clients in content item storage 110.

FIG. 6B illustrates an example method for handling a put ( ) request for a non-latency-sensitive client in accordance with some embodiments of the present technology. Although the example method depicts a particular sequence of operations, the sequence may be altered without departing from the scope of the present disclosure. For example, some of the operations depicted may be performed in parallel, may be excluded or added, or may be performed in a different sequence that does not materially affect the function of the method. In other examples, different components of an example device or system that implements the method may perform functions at substantially the same time or in a specific sequence.

In some embodiments, a client is a non-latency-sensitive client because it is making a non-latency-sensitive put ( ) request where it is not expected that the data block to be written by the put ( ) request will need to be accessed soon.

According to some examples, the method includes selecting the first plurality of object storage devices at block 614. For example, the storage master 311 illustrated in FIG. 3 may select the first plurality of object storage devices. The first plurality of object storage devices includes sixteen object storage devices with sufficiently independent failure domains (the destinations). The first plurality of object storage devices to be associated with twelve bucket identifiers containing data blocks including the first data block to be erasure coded.

According to some examples, the method includes instructing the acceptor service to create a session with the first plurality of object storage devices at block 616. For example, the storage master 311 illustrated in FIG. 3 may instruct the acceptor service to create a session with the first plurality of object storage devices (e.g., the sixteen object storage devices with sufficiently independent failure domains with twelve bucket identifiers). The session is an erasure coding session using acceptor service 502 as the data source.

In some embodiments, the operations performed with respect to block 614 and block 616 can have occurred even prior to receiving the put ( ) request at block 610. The operations performed with respect to block 614 and block 616 are performed independently and can prepare the object storage devices to handle the non-latency-sensitive request.

According to some examples, after it has been determined that the client making the put ( ) request is a non-latency-sensitive client, the method includes temporarily buffering the first data block at block 618. For example, the acceptor service 502 illustrated in FIG. 5 may temporarily buffer the first data block. As noted above, the reference to the first data block means at least a first data block and there can be many first data blocks.

In some embodiments, the acceptor service 502 is a service that exists to be called by non-latency-sensitive clients. As addressed herein, non-latency-sensitive clients do not need access to the data blocks they are putting into the storage system, which means that it is not necessary to store the data blocks in a temporary way just to make them accessible very quickly. Instead, the content item storage 110 can prioritize efficiently storing the data blocks in a more persistent way.

One way that storage of the first data blocks in response to the put ( ) request can be made more efficient is to avoid replication of the data blocks. Since latency-sensitive clients need the data quickly, content item storage 110 doesn't generally have the time to perform erasure coding on the data, which achieves the dual function of some amount of duplication and provides a fault recovery mechanism. Since content item storage 110 doesn't have time to do erasure coding, content item storage 110 performs replication to at least provide some minimal amount of redundancy in case an object storage device fails. But, since FIG. 6B pertains to a non-latency-sensitive client, there is no need to temporarily store replicated data, and therefore, the temporary buffering of the first data block does not include replicating the first data block.

According to some examples, the method includes temporarily buffering a second plurality of data blocks until a predetermined amount of data blocks are buffered by the acceptor service at block 620. For example, the acceptor service 502 illustrated in FIG. 5 may temporarily buffer a second plurality of data blocks until a predetermined amount of data blocks are buffered by the acceptor service. The temporarily buffering of the second plurality of data blocks also does not include replicating the second plurality of data blocks.

The actions performed in association with block 620 occur because content item storage 110 doesn't erasure code data blocks individually, or even on a per content item basis. Rather, another efficiency of the content item storage 110 is that it performs erasure coding on multiple extents worth of data. In some embodiments, the present technology aggregates data from twelve extents, which is about 24 gibibytes of data. However, the present technology is not limited to any specific number of extents, volumes, object storage devices, or amount of data that is aggregated prior to performing the erasure coding.

According to some examples, the method includes acknowledging the put ( ) request to a requesting client at block 622. For example, the acceptor service 502 illustrated in FIG. 5 may acknowledge the put ( ) request to a requesting client. While the block cannot yet be considered durably stored, nor is it readable, acceptor service 502 can acknowledge the put ( ) request. This is in contrast to the process for latency-sensitive clients illustrated in FIG. 6C, where the acknowledgment is sent after the client can make a get ( ) request for the data (i.e., after the first data block is replicated and stored), which does not occur for non-latency-sensitive clients.

In some embodiments, acceptor clients 504 are configured to also be resilient to failure to receive an acknowledgment or receiving an error. If no acknowledgement is received or an error is received, acceptor client 504 can retry to the put ( ) request.

Since the non-latency-sensitive client receives the acknowledgment of the put ( ) request before the first data block is accessible via a get ( ) request, the acknowledgment does not include information about how the block is identified or where it is stored. Therefore, if the non-latency-sensitive client desires to be able to make a get ( ) request after the data is stored, the non-latency-sensitive client can provide a callback address to be notified later when the block is committed and readable.

While FIG. 6B illustrates the acknowledgment occurring at this place in the method; it should be appreciated that the acknowledgment could come after the first data blocks are erasure-coded and available to be returned to clients in response to a get ( ) request.

According to some examples, the method includes causing the erasure coding to be performed by a volume manager at block 624. For example, the acceptor service 502 illustrated in FIG. 5 may cause the erasure coding to be performed by a volume manager by providing the first plurality of object storage devices (e.g., the sixteen object storage devices with sufficiently independent failure domains with twelve bucket identifiers) to the volume manager 506.

According to some examples, the method includes reading data blocks, including the first data block and the second plurality of data blocks from the acceptor service at block 626. For example, the volume manager 506 illustrated in FIG. 5 may read data blocks, including the first data block and the second plurality of data blocks from the acceptor service. The actions performed with respect to block 626 and block 624 can be performed recursively until the acceptor service returns blank chucks.

According to some examples, the method includes encoding the data blocks into stripes on scratch extents on the second plurality of object storage devices using the erasure coding scheme at block 628. For example, the volume manager 506 illustrated in FIG. 5 may encode the data blocks into stripes on scratch extents on the second plurality of object storage devices using the erasure coding scheme. A stripe is a chunk of contiguous data in a volume.

In some embodiments, erasure coding scheme is a Local Reconstruction Codes (LRC) scheme. The LRC scheme allows for efficiently reconstructing data blocks in case of failed object storage devices. Local Reconstruction Codes (LRC) are a type of erasure coding designed to optimize the efficiency of data recovery in distributed storage systems. LRC adds an extra layer of redundancy by grouping data blocks into subsets, each with its own local parity checks, in addition to the global parity checks found in traditional erasure coding schemes. This dual-level structure allows for the recovery of lost or corrupted data blocks by accessing a smaller subset of the total storage nodes, thereby reducing the amount of data that needs to be read and transmitted over the network. This makes LRC particularly effective for improving the speed and reducing the bandwidth requirements for data reconstruction, enhancing both the performance and reliability of distributed storage systems. In some embodiments, content item storage 110 uses LRC(12, 2, 2), which means 12 data disks, 2 local parity disks, and 2 global parity disks per encoded volume.

Eventually, the acceptor service 502 will begin sending empty blocks to the volume manager, which is an indication that acceptor has no more data to erasure code as part of this session, and the volume manager can finish writing its stripes to the destination scratch extents.

According to some examples, the method includes sending names of the scratch extent names storing the data blocks to the acceptor service at block 630. For example, the object storage device 313 illustrated in FIG. 3 may send names of the scratch extent storing the data blocks to the acceptor service. A scratch extent is a temporary extent which has a randomly-generated name which is used when encoding is in progress.

According to some examples, the method includes forwarding the names of the scratch extents to the storage master at block 632. For example, the acceptor service 502 illustrated in FIG. 5 may forward the names of the scratch extents to the storage master.

According to some examples, the method includes instructing the first plurality of object storage devices containing the scratch extents to rename the scratch extents into an encoded volume at block 634. For example, the storage master 311 illustrated in FIG. 3 may instruct the first plurality of object storage devices containing the scratch extents to rename the scratch extents into an encoded volume, which is a persistent volume, generally with multiple buckets, and that follows a naming scheme utilized throughout the content item storage 110.

According to some examples, the method includes causing the acceptor service to close the session at block 636. For example, the storage master 311 illustrated in FIG. 3 may cause the acceptor service to close the session.

According to some examples, the method includes instructing the content item block database to store an identifier and storage locations for the first data block to a content item block database at block 638. For example, the acceptor service 502 illustrated in FIG. 5 may instruct the content item block database to store an identifier and storage locations for the first data block to a content item block database.

At this point the first data block is considered persistently stored and is retrievable by clients. If the non-latency-sensitive client requested a call back to be notified later when the block is committed and readable, acceptor service 502 can call the client with such a notification.

FIG. 6C illustrates an example method for handling a put ( ) request for a latency-sensitive client in accordance with some embodiments of the present technology. Although the example method depicts a particular sequence of operations, the sequence may be altered without departing from the scope of the present disclosure. For example, some of the operations depicted may be performed in parallel, may be excluded or added, or may be performed in a different sequence that does not materially affect the function of the method. In other examples, different components of an example device or system that implements the method may perform functions at substantially the same time or in a specific sequence.

In some embodiments, a client is a latency-sensitive client because it is making a latency-sensitive put ( ) request that is a latency-sensitive request because the data block to be written by the put ( ) request might need to be accessed soon.

After it has been determined that the client making the put ( ) request is a latency-sensitive client (block 612 in FIG. 6A), the method proceed to FIG. 6C, where the content item storage 110 performs an extra operation of replicating data blocks so that the data blocks can be quickly accessible by clients of the content item storage 110. Later, in an asynchronous process, the content item storage 110 will more persistently store the data using an erasure coding technique.

In the context of content management system 102, illustrated in FIG. 1, a latency-sensitive client can be the client application 116 or the web interface service 108. These clients can receive a new content item or a change to a content item and need to store the data blocks associated with the content item so that other client applications 116/web interface service 108 can access the latest version of the content item. This is particularly important with a shared content item in the synchronized content management system, where a first client might send a put ( ) request with a new data block, while the server synchronization service 104 informs other client devices that the content item has been updated. Very quickly, at least some of those client devices will send get ( ) requests to retrieve the updated data. Thus, it might not be that the client that is making the put ( ) request will need the data blocks quickly, it might be that the type of data or the circumstance in which the data is being stored that makes a client a latency-sensitive client.

FIG. 6C illustrates steps in the initial storage and replication process with respect to block 640-block 654 and steps in the asynchronous erasure coding with respect to block 656-block 658.

According to some examples, the method includes requesting and receiving the open volume from the bucket database at block 640. For example, the storage master 311 illustrated in FIG. 3 may request and receive the open volume from the bucket database. The open volume was created at block 604 in FIG. 6A so that the content item storage 110 could be ready for a put ( ) request from a latency-sensitive client.

According to some examples, the method includes selecting a first object storage device of the first plurality of object storage devices associated with the open volume at block 642. For example, the storage master 311 illustrated in FIG. 3 may select an object storage device of the first plurality of object storage devices associated with the open volume.

According to some examples, the method includes causing the first data block to be written to the first object storage device at block 644. For example, the storage master 311 illustrated in FIG. 3 may cause the first data block to be written to the first object storage device.

According to some examples, the method includes storing the first data block to the first object storage device at block 646. For example, the object storage device 313 illustrated in FIG. 3 may store the first data block to the first object storage device.

According to some examples, the method includes replicating the first data block to a first plurality of disks of the data storage system at block 648. For example, the object storage device 313 illustrated in FIG. 3 may replicate the first data block to a first plurality of disks of the data storage system. The replicating includes sending the first data block to at least one other object storage device of the first plurality of object storage devices in the volume. In some embodiments, the first plurality of object storage devices are four object storage devices.

According to some examples, the method includes respectively storing, by at least one other object storage device of the first plurality of object storage devices in the volume, the first data block at block 650. For example, the object storage device 313 illustrated in FIG. 3 may respectively store, by at least one other object storage device of the first plurality of object storage devices in the volume, the first data block. The first data block is redundantly stored on the first plurality of object storage devices. For example, the first data block can be redundantly stored four times by storing four copies of the first data block on four different object storage devices.

According to some examples, the method includes acknowledging the put request to the storage front end at block 652. For example, the storage master 311 illustrated in FIG. 3 may acknowledge the put request to the storage front end. At this point, the client receiving the acknowledgment, and other clients are free to send a get ( ) request to retrieve the first data block.

According to some examples, the method includes adding an identifier and storage locations for the first data block to a content item block database at block 654. The first data block is considered persistently stored and is retrievable by clients.

The steps addressed with respect to block 640-block 654 are sufficient to store the first data block in content item storage 110 in a way that mitigates data loss from a bad object storage device, and that makes the first data block available quickly, but it is a better practice in the management of content storage systems to store data using erasure coding. Erasure coding allows the content item storage 110 to store data blocks in a way that is resilient to object storage device failures, and that takes up less storage capacity than replicating data blocks.

The erasure coding can happen at some later time, in an asynchronous process, which is described with respect to block 656-block 658. This erasure coding process is mostly similar to the erasure coding process described in FIG. 6B, except for the source of the data. Rather than the acceptor service being the source of the data blocks to be erasure coded, the first data blocks stored on the object storage devices are the source. Another difference is that since the first data blocks are already accessible to clients, the content item block database needs to be revised to reflect the new locations of the data blocks after the erasure coding, as is addressed below.

According to some examples, the method includes selecting the second plurality of object storage devices at block 656. For example, the storage master 311 illustrated in FIG. 3 may select the second plurality of object storage devices. The second plurality of object storage devices include sixteen object storage devices with sufficiently independent failure domains (the destinations). The second plurality of object storage devices is to be associated with twelve closed volumes (the sources) containing data blocks, including the first data block to be erasure coded. Thus, just like in FIG. 6B, the first data blocks will be erasure coded with additional data blocks for additional efficiency.

According to some examples, the method includes causing the erasure coding to be performed by a volume manager at block 658. For example, the storage master 311 illustrated in FIG. 3 may cause the erasure coding to be performed by a volume manager.

According to some examples, the method includes reading data blocks including the first data block from source volumes at block 660. For example, the volume manager 506 illustrated in FIG. 5 may read data blocks, including the first data block from source volumes.

According to some examples, the method includes encoding the data blocks into stripes on scratch extents on the second plurality of object storage devices using the erasure coding scheme at block 662. For example, the volume manager 506 illustrated in FIG. 5 may encode the data blocks into stripes on scratch extents on the second plurality of object storage devices using the erasure coding scheme. The erasure coding scheme is a Local Reconstruction Codes (LRC) scheme.

According to some examples, the method includes sending names of the scratch extent names storing the data blocks to the storage master at block 664. For example, the volume manager 506 illustrated in FIG. 5 may send names of the scratch extent names storing the data blocks to the storage master.

According to some examples, the method includes instructing the second plurality of object storage devices containing the scratch extents to rename the scratch extents into an encoded volume at block 666. For example, the storage master 311 illustrated in FIG. 3 may instruct the second plurality of object storage devices containing the scratch extents to rename the scratch extents into an encoded volume.

According to some examples, the method includes instructing the content item block database to replace the storage locations for the first data block prior to the erasure coding to the storage locations for the first data block on the second plurality of object storage devices after the erasure coding at block 668. For example, the storage master 311 illustrated in FIG. 3 may instruct the content item block database to replace the storage locations for the first data block prior to the erasure coding to the storage locations for the first data block on the second plurality of object storage devices after the erasure coding.

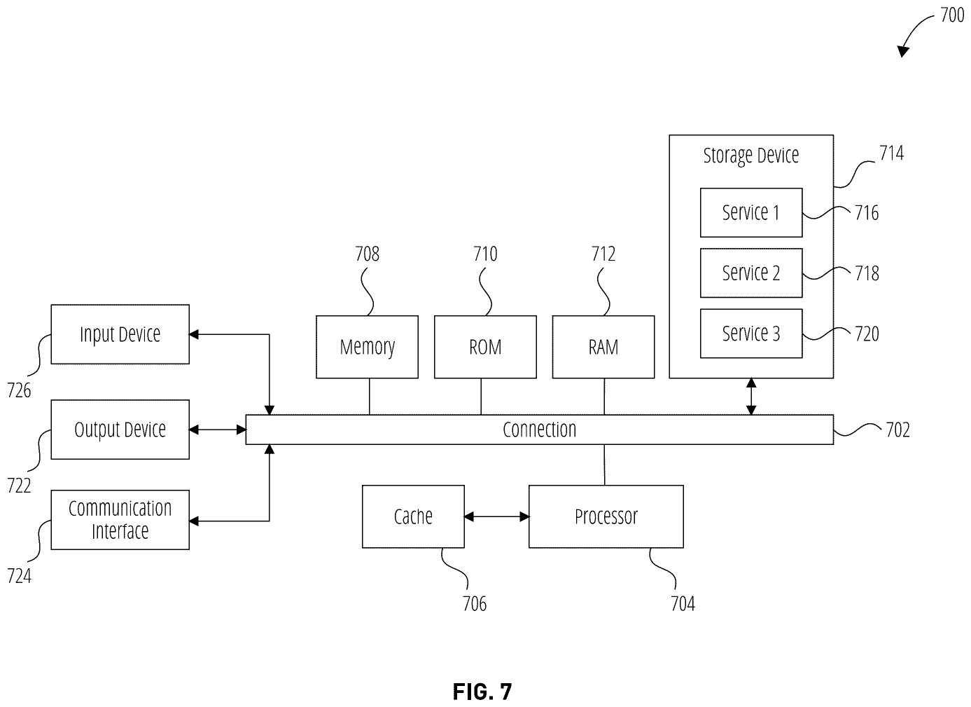

FIG. 7 shows an example of computing system 700, which can be for example any computing device making up content item storage 110, or any component thereof in which the components of the system are in communication with each other using connection 702. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) 704 and connection 702 that couples various system components including system memory 708, such as read-only memory (ROM) 710 and random access memory (RAM) 712 to processor 704. Computing system 700 can include a cache of high-speed memory 706 connected directly with, in close proximity to, or integrated as part of processor 704.

Processor 704 can include any general purpose processor and a hardware service or software service, such as services 716, 718, and 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

For clarity of explanation, in some instances, the present technology may be presented as including individual functional blocks including functional blocks comprising devices, device components, steps or methods in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or methods in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### Aspects:

The present technology includes computer-readable storage mediums for storing instructions, and systems for executing any one of the methods embodied in the instructions addressed in the aspects of the present technology presented below:

Aspect 1: A method comprising collecting a plurality of data blocks for in a buffer until a threshold amount of data blocks are present in the buffer; and after the threshold amount of blocks are present in the buffer, erasure coding the plurality of data blocks onto a plurality of disks, without replicating the plurality of data blocks to any one of a plurality of disks of a storage system. The first plurality of disks of the data storage system are distributed across multiple servers

Aspect 2: The method of claim 6, further comprising: prior to collecting a first data block in the buffer, determining that the first data block is a non-latency-sensitive request of a data storage system.

Aspect 3: The method of any one of Aspects 1-2, further comprising: sending a put ( ) request acknowledgment in response to the non-latency-sensitive request prior to the plurality of data blocks being accessible from the storage system.

Aspect 4: The method of any one of Aspects 1-3 wherein the non-latency-sensitive request provides a callback address to be notified when the first data block is accessible from the storage system.

Aspect 5: The method of any one of Aspects 1-4, wherein it is determined that the first data block part of a non-latency-sensitive request when the client accesses the data storage system through an acceptor service.

Aspect 6: The method of any one of Aspects 1-5, further comprising: determining that a first data block is part of a latency-sensitive request of a data storage system; replicating the first data block to at least two of the plurality of disks; sending a put ( ) request acknowledgment indicating that the first data block is stored and accessible from the storage system; and after replicating the first data block to the at least two of the plurality of disks, erasure coding the first data block to additional disks of the plurality of disks.

Aspect 7: The method of any one of Aspects 1-6, wherein it is determined that the first data block is part of the latency-sensitive request when the client accesses the data storage system through a storage front end.

1. A non-transitory computer-readable storage medium comprising instructions that when executed by at least one processor, cause the at least one processor to:
determine that a first data block is received in association with a latency-sensitive request of a data storage system, wherein the determination is based on a source of the first data block, a type of a write request associated with the first data block, or an indication that the first data block needs to be accessed;
in response to determining that the first data block is received in association with the latency-sensitive request of the data storage system:
replicate the first data block to a first plurality of disks of the data storage system, and
after replicating the first data block to the first plurality of disks, erasure coding the first data block to a second plurality of disks of the data storage system, the first plurality of disks of the data storage system are distributed across multiple servers;
determine that a second data block is received in association with a non-latency-sensitive request of the data storage system; and
in response to determining that the second data block is received in association with the non-latency-sensitive request of the data storage system:
erasure code the second data block to the second plurality of disks without replicating the second data block, the second plurality of disks of the data storage system are distributed across multiple servers.

2. The non-transitory computer-readable storage medium of claim 1, wherein the instructions further configure the at least one processor to:
send a put ( ) request acknowledgment to the non-latency-sensitive request prior to the second data blocks being accessible from the data storage system.

3. The non-transitory computer-readable storage medium of claim 1, wherein the non-latency-sensitive request comes with a callback address to be notified when the first data block is accessible from the data storage system.

4. The non-transitory computer-readable storage medium of claim 1, wherein it is determined that the first data block is from a non-latency-sensitive request when the non-latency-sensitive request is received by an acceptor service.

5. The non-transitory computer-readable storage medium of claim 1, wherein it is determined that the first data block is from the latency-sensitive request when latency-sensitive client is received by a storage front end.

6. A method comprising:
determining that a first plurality of data is received in association with a latency-sensitive request of a data storage system, wherein the determining is based on a source of the first data block, a type of a write request associated with the first data block, or an indication that the first data block needs to be accessed;
in response to determining that the first plurality of data is received in association with the latency-sensitive request of the data storage system:
replicating the first plurality of data to a first plurality of disks of the data storage system, and
after replicating the first plurality of data to the first plurality of disks, erasure coding the first plurality of data to a second plurality of disks of the data storage system, the first plurality of disks of the data storage system are distributed across multiple servers;
determining that a second plurality of data is received in association with a non-latency-sensitive request of the data storage system;
collecting a second plurality of data blocks in a buffer; and
erasure coding the second plurality of data blocks onto a second plurality of disks of a storage system, without replicating the second plurality of data blocks to any one of the second plurality of disks of the storage system, wherein the erasure coding is performed using a local reconstruction code (LRC) erasure coding scheme.

7. The method of claim 6, wherein the erasure coding the second plurality of data blocks onto the second plurality of disks begins after there is a threshold amount of data blocks present in the buffer.

8. (canceled)

9. The method of claim 6, further comprising:
sending a put ( ) request acknowledgment in response to the non-latency-sensitive request prior to the first plurality of data being accessible from the data storage system.

10. The method of claim 9, wherein the non-latency-sensitive request provides a callback address to be notified when the second plurality of data is accessible from the data storage system.

11. (canceled)

12. The method of claim 6, further comprising:
determining that a first data block is part of a latency-sensitive request of a data storage system;
replicating the first data block to at least two of the first plurality of disks;
sending a put ( ) request acknowledgment indicating that the first data block is stored and accessible from the data storage system; and
after replicating the first data block to the at least two of the first plurality of disks, erasure coding the first data block to additional disks of the first plurality of disks.

13. The method of claim 12, wherein it is determined that the first data block is part of the latency-sensitive request when a client accesses the data storage system through a storage front end.

14. A computing system comprising:
at least one processor; and
a memory storing instructions that, when executed by the at least one processor, configure the computing system to:
determine that a first plurality of data is received in association with a latency-sensitive request of a data storage system, wherein the determination is based on a source of the first data block, a type of a write request associated with the first data block, or an indication that the first data block needs to be accessed;
in response to determining that the first plurality of data is received in association with the latency-sensitive request of the data storage system:
replicate the first plurality of data to a first plurality of disks of the data storage system, and
after replicating the first plurality of data to the first plurality of disks, erasure coding the first plurality of data to a second plurality of disks of the data storage system, the first plurality of disks of the data storage system are distributed across multiple servers;
determine that a second plurality of data is received in association with a non-latency-sensitive request of the data storage system;
collect the second plurality of data in a buffer; and
after the second plurality of data are present in the buffer, erasure coding the second plurality of data onto the second plurality of disks without replicating the second plurality of data to any one of the second plurality of disks of a storage system, the second plurality of disks of the data storage system are distributed across multiple servers.

15. (canceled)

16. The computing system of claim 14, wherein the instructions further configure the computing system to:
send a put ( ) request acknowledgment in response to the non-latency-sensitive request prior to the second plurality of data being accessible from the storage system.

17. The computing system of claim 16, wherein the non-latency-sensitive request includes a callback address to be notified when the second plurality of data is accessible from the storage system.

18. The computing system of claim 16, wherein it is determined that the second plurality of data is part of the non-latency-sensitive request when the non-latency-sensitive request is received through an acceptor service.

19. The computing system of claim 14, wherein the instructions further configure the computing system to:
determine that a first data block is received as part of a latency-sensitive request of a data storage system;
replicate the first data block to at least two of the first plurality of disks;
send a put ( ) request acknowledgment indicating that the first data block is stored and accessible from the storage system; and
after replicating the first data block to the at least two of the first plurality of disks, erasure coding the first data block to additional disks of the first plurality of disks.

20. The computing system of claim 14, wherein the erasure coding is performed using a local reconstruction code (LRC) erasure coding scheme.

21. The non-transitory computer-readable storage medium of claim 1, wherein the determination is based on identifying the source of the first data block as a storage front end or the type of the write request is a live write.

22. The method of claim 6, wherein the determining is based on identifying the source of the first data block as a storage front end or the type of the write request is a live write.

23. The computing system of claim 14, wherein the determination is based on identifying the source of the first data block as a storage front end or the type of the write request is a live write.
